(19) United States
(12) Patent Application Publication
(10) Pub. No.: US 2004/0128206 A1
(43) Pub. Date: Jul. 1, 2004

(54) Book resource recycling system

(76) Inventor: Wen Fu Peng, Taipei (TW)

Correspondence Address: WEN FU PENG, P.O. BOX 26-757, TAIPEI, 106, TW

(21) Appl. No.: 10/336,492

(22) Filed: Dec. 30, 2002

(51) Int. Cl. G06F 17/60

(52) U.S. Cl. 705/26

(57) ABSTRACT

A book resource recycling system for providing a channel for people to buy or sell the secondhand books comprises: a book resource recycling server, store terminals and a member terminal. The book resource recycling server has a book resource recycling center for obtaining a commerce record from the store terminals via the network. The store terminals and member terminal also can obtain book inquiry data from the book resource recycling server via the network. Therefore, the system can provide the channel for people to buy/sell the secondhand books so as to reduce the waste of the book resource.

### FIELD OF THE INVENTION

The present invention is directed to a book resource recycling system, and more particularly, to a book resource recycling system that can provide a channel for people to buy or sell the secondhand books.

### BACKGROUND OF THE INVENTION

From ancient times to the present, books always are the important media for preserving and spreading the knowledge and wisdom. However, excessive publication and sale of the books will result in overspending the resource of the earth, e.g. the deforestation will increase. Moreover, conventionally, most of the bookstores usually provide new books to consumers and most of the consumers are also used to buy new books. Even though the consumers want to buy or sell the secondhand books with reasonable prices, they do not have an appropriate channel. Therefore, the more books are bought, the more resource of the earth is wasted.

Accordingly, as discussed above, the conventional marketing of the books obviously still has some drawbacks that could be improved. The present invention aims to resolve the drawbacks in the prior art.

### SUMMARY OF THE INVENTION

The main objective of the present invention is to provide a book resource recycling system for making the book resource able to be used repeatedly so that the waste of the earth resource can be decreased, e.g. the deforestation can be reduced.

The other objective of the present invention is to provide a channel for people to sell or recycle the secondhand books for reducing the waste of the room and the disbursement of books.

In order to reach the objectives described above, the present invention provides a book resource recycling system including: a book resource recycling server, store terminals and a member terminal. The book resource recycling server comprises a book resource recycling control center and a network interface. The book resource recycling control center can obtain a store commerce record from the store terminals via the network interface. The store terminals and member terminal also comprise a network interface, respectively, and can get a book inquiry data from the book resource recycling control center via the network interface. Therein, the store commerce record comprises a buying/selling record of the new books or secondhand books and the book inquiry data comprises the data of the conditions of the new books or the secondhand books. Therefore, the book resource recycling system of the present invention can provide a channel for people to buy or sell the secondhand books so that it can reduce the waste of the book resource.

Numerous additional features, benefits and details of the present invention are described in the detailed description, which follows.

### BRIEF DESCRIPTION OF THE DRAWINGS

FIG. 1 is a system arrangement diagram of the present invention.

FIG. 2 is an internal architecture diagram of the system complied with the present invention.

FIG. 3 is an operative flow chart of the present invention.

### DETAILED DESCRIPTION

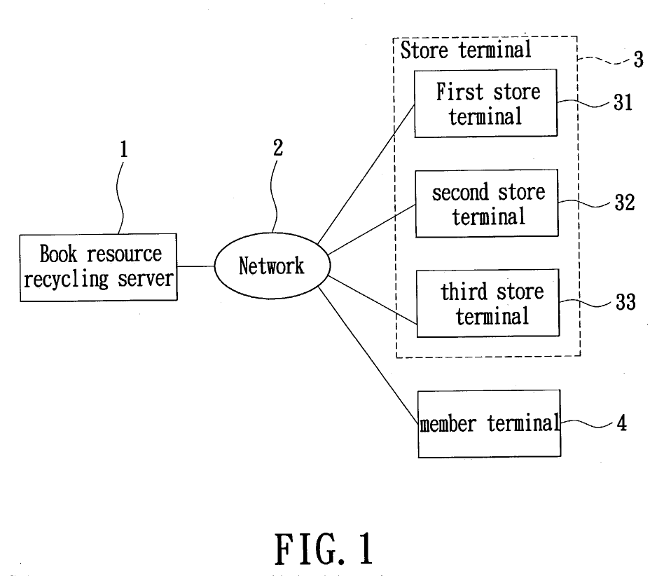

Please refer to FIG. 1, which is the arrangement diagram of the present invention. The book resource recycling system complied with the present invention comprises a book resource recycling server 1, a network 2, store terminals 3 and a member terminal 4. Therein, the store terminals 3 and a member terminal 4 communicate with the book resource recycling server 1 via the network 2.

The store terminals 3 comprise a first store terminal 31, a second store terminal 32 and a third store terminal 33. The first store terminal 31, second store terminal 32 and third store terminal 33 are disposed in different stores, respectively. In practice, the number of the store terminals 3 can be increased or decreased in accordance to the need of the users.

Moreover, the member terminal 4 is a general personal computer that is capable of connecting to the network 2. In practice, all members (in principle, the member is the one who ever bought a book from the book store of the system complied with the present invention) can use their personal computer to communicate with the book resource recycling server 1 via the network 2.

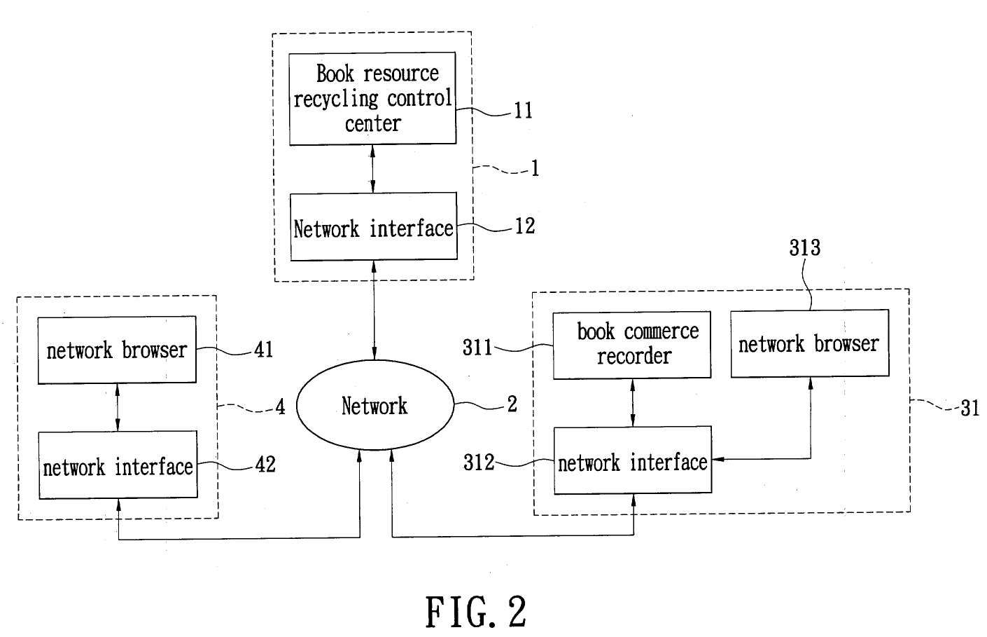

Please refer to FIG. 2, which is the internal architecture diagram of the system complied with the present invention. Therein, the book resource recycling server 1 further comprises a book resource recycling control center 11 and a network interface 12. The book resource recycling control center 11 can communicate with the store terminals 3 and member terminal 4 via the network interface 12.

The first store terminal 31 further comprises a book commerce recorder 311, a network interface 312 and a network browser 313. Therein, the book commerce recorder 311 and network browser 313 both communicate with the book resource recycling server 1 via the network browser 313 to upload or download the commerce record of the book stores. The clerks can use the first store terminal 31 to look up the related information of the books, e.g. price, category and quality, etc., or to input the commerce record. (The second store terminal 32 and third store terminal 33 have the same inner structures, functions and operations as the first store terminal 31.)

The member terminal 4 further comprises a network browser 41 and a network interface 42. The member of the system can use the network browser 41 to surf the web site of the book resource recycling control center 11 via the network interface 42 so as to inquire the related information about the books, e.g. price, category and quality, etc.

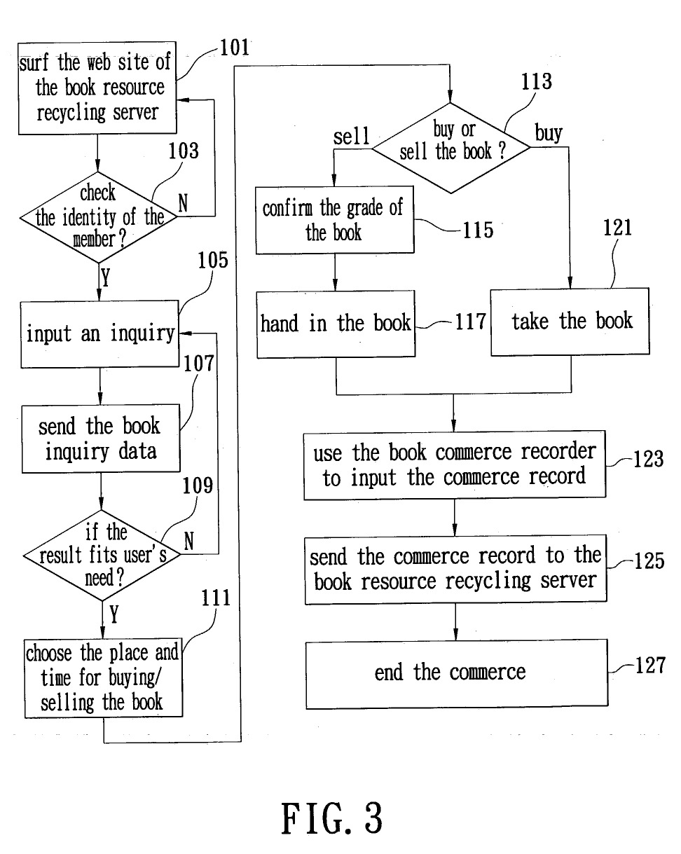

Please refer to FIG. 3, which is the operative flow chart of the present invention. It is described as following:

Step 101: Initially, the member and clerk, i.e. the user, of the system can respectively use the member terminal 4 and the store terminals 3 to surf the web site of the book resource recycling server 1 via the network 2.

Step 103: After connecting with the book resource recycling server 1, the book resource recycling control center 11 will first check the identity of the user. If the user's identity is accepted, then go to step 105. Otherwise, jump back to step 101.

Step 105: At this step, the user can input his inquiry to search the information of books. For example, the user can input the state of the book he wants to sell (in principle, the system of the present invention only retrieves the book sold from the store of the system itself), i.e. the buying day, if its attachment still exists, etc. Moreover, the user also can input the conditions of the book he wants to buy, i.e. the name of the book (or the keyword), new or secondhand book and prices, etc.

Step 107: After the user inputs his inquiry, the book resource recycling control center 11 will deal with the inquiry and send the result, i.e. book inquiry data, back to the member terminal 4 or the store terminals 3. In this step, the book resource recycling control center 11 will estimate the price of the book the user wants to sell according to its state, or list the books that fit the conditions of the book the user wants to buy.

Step 109: Then, the user can determine if the result fits his need, i.e. the user can determine if he will sell the book according to estimated price provided in the result, or determine if he will buy a book listed in the result. If the user determines to sell or buy, go to step 111. Otherwise, jump back to step 105.

Step 111: At this step, the book resource recycling control center 11 will list the available times and places (i.e. the stores of the system). Then, the user can chose one of the listed times and places for buying/selling the book. After the user makes the decision, the book resource recycling control center 11 will send the information of the chosen time and book and the identity of the user to store terminal 3 of the chosen store.

Step 113: If the user will buy a book, go to step 121. If the user will sell a book, go to step 115.

Step 115: The user can deliver the book in accordance with the chosen time and place. Then, the clerk of the chosen store can use the store terminal 3 and the serial number and state of the book to confirm the estimated price and grade of the book.

Step 117: After confirming the estimated price and grade of the book, the user can hand in the book and get the money. Then, go to step 123.

Step 121: The user can go to get the ordered book and pay the money at the chosen time and place. Then, go to step 123.

Step 123: At this step, the clerk can use the book commerce recorder 311 of the store terminal 3 to input the commerce record of the book.

Step 125: Then, the book commerce recorder 311 will send the commerce record of the book to the book resource recycling server 1 for the clerks and members of the system to inquire later.

Step 127: Then, end the commerce.

Therein, the user can use the cash or credit card to pay for the book he ordered. Moreover, the user also can use the identity card issued by the operator of the system to pay for the book via deducting the number of points of the identity card equal to the price of the book. On the other hand, the operator of the system also can use the cash or increase the number of point of the identity card equal to the price of the book to pay for the book the user sold.

Moreover, in the steps above, the grades and prices of the books can be determined in accordance with the following criteria. In principle, the secondhand books can be classified into three kinds of grades, which are grade A, B and C, respectively.

Grade A: The text and covers of the book should be clear and complete without any marks. Moreover, the book should be sold within six months after the buying day. The books at this grade can be retrieved in accordance with a half of the original price and sold with thirty percent discount of the original price later.

Grade B: The text and covers of the book should be clear and complete without any marks. Moreover, the book should be sold between six months and one year after the buying day. The books at this grade can be retrieved in accordance with thirty percent of the original price and sold with fifty percent discount of the original price later.

Grade C: The text and covers of the book should be clear and complete without any marks. Moreover, the book should be sold between one and three years after the buying day. However, the books having some portions fading or not intact (the text should be complete), or having some marks therein also can be in this grade. The books at this grade can be retrieved in accordance with ten percent of the original price and sold with seventy percent discount of the original price later.

Furthermore, the operator of the system complied with present invention also can retrieve the secondhand books excluded from the grades above and later present them to the library, school or charitable organization, etc, to prevent the book resource from waste.

However in practice, the operator of the system can modify the criteria mentioned above according to his need. For example, the books, whose prices are above one thousand dollars, can be classified into five kinds of grades; and the books, whose prices are below one hundred dollars, only can be classified into one kind of grade, etc.

Summing up, the present invention has following features and advantages:

(1) The book resource recycling system complied with the present invention can make the book resource be used repeatedly so as to reduce the waste of the resource of the earth, i.e. decreasing the deforestation.

(2) The system complied with the present invention can provide the users a channel to sell or recycle the unneeded books. Therefore, it is not necessary for the users to waste the room to store the unneeded books and the disbursement of the books can be reduced.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are embraced within the scope of the invention as defined in the appended claims.

What is claimed is:

1. A book resource recycling system comprising:
a book resource recycling server, which has a book resource recycling control center and a first network interface, the book resource recycling control center being connected with the first network interface so as to obtain a commerce record via the first network interface and a network; and
store terminals each having a second network interface, the store terminals being connected with the book resource recycling server via the second network interface and the network, and obtaining book inquiry data from or delivering the commerce record to the book resource recycling server;
wherein the commerce record comprises a buying record of a new book or a buying/selling record of a secondhand book and the book inquiry data comprises an information relating to a state of the new book or secondhand book; therefore, the book resource recycling system provides a channel for buying/selling the secondhand book so as to reduce the waste of a book resource.

2. The book resource recycling system as claimed in claim 1, wherein the book terminals each further comprises a book commerce recorder for recording the commerce record and delivering the commerce record to the book resource recycling control center.

3. The book resource recycling system as claimed in claim 1, wherein the book terminals each further comprises a network browser, which is used to obtain the book inquiry data via the second network interface.

4. The book resource recycling system as claimed in claim 1, wherein the system further comprises a member terminal, which is used for a member to obtain the book inquiry data.

5. The book resource recycling system as claimed in claim 4, wherein the member terminal comprises a network browser and a network interface for the member to use the network browser to obtain the book inquiry data via the network interface and the network.

6. An operation method of a book resource recycling system, wherein the book resource recycling system has a book resource recycling server and a store terminal, and the store terminal connects and communicates with the book resource recycling server via a network, the method comprising:
using the store terminal to surf a web site of the book resource recycling server;
using the store terminal to input a buying/selling inquiry to search information of a book;
employing the book resource recycling server to send book inquiry data back to the store terminal according to the inquiry;
choosing a place and time from available times and places provided by the book resource recycling server for buying/selling the book
using a book commerce recorder of the store terminal to input a commerce record of the book after buying/selling the book; and
employing the commerce recorder to send the commerce record to the book resource recycling server.

7. The method as claimed in claim 6 further comprising checking an identity of a member after using the store terminal to surf the web site of the book resource recycling server.

8. An operation method of a book resource recycling system, wherein the book resource recycling system has a book resource recycling server, a store terminal and a member terminal, the store terminal and member terminal connect and communicate with the book resource recycling server via a network, the method comprising:
using the member terminal to surf a web site of the book resource recycling server;
using the member terminal to input a buying/selling inquiry to search information of a book;
employing the book resource recycling server to send book inquiry data back to the member terminal according to the inquiry;
choosing a place and time from available times and places provided by the book resource recycling server for buying/selling the book;
using a book commerce recorder of the store terminal to input a commerce record of the book after buying/selling the book; and
employing the commerce recorder to send the commerce record to the book resource recycling server.

9. The method as claimed in claim 8 further comprising checking an identity of a member after using the store terminal to surf the web site of the book resource recycling server.
